(19) United States
(12) Patent Application Publication
(10) Pub. No.: US 2013/0220917 A1
(43) Pub. Date: Aug. 29, 2013

(54) CERAMIC MADE OF PRECERAMIC PAPER AND/OR CARDBOARD STRUCTURES

(71) Applicant: Peter Bolduan, Ladbergen (DE)

(72) Inventor: Peter Bolduan, Ladbergen (DE)

(73) Assignee: ATECH INNOVATIONS GMBH, Gladbeck (DE)

(21) Appl. No.: 13/884,280

(22) PCT Filed: Oct. 31, 2011
(86) PCT No.: PCT/EP11/05488

§ 371 Date: May 9, 2013

(30) Foreign Application Priority Data
Nov. 9, 2010 (DE) 10 2010 050 641.9
Dec. 1, 2010 (DE) 10 2010 052 906.0
Feb. 2, 2011 (DE) 10 2011 010 179.9
Feb. 9, 2011 (DE) 10 2011 010 800.9
Feb. 9, 2011 (DE) 20 2011 105 717.9
Jun. 7, 2011 (DE) 10 2011 104 141.2
Jun. 7, 2011 (DE) 10 2011 116 100.0
Oct. 5, 2011 (DE) 10 2011 114 843.8

(51) Int. Cl. B01D 39/20; C04B 35/00

(52) U.S. Cl. CPC B01D 39/2068; C04B 35/00
USPC 210/487; 428/116; 210/486

(57) ABSTRACT

A ceramic which can be obtained from a composite of at least two outer pre-ceramic paper and/or cardboard structures (1, 2) as cover layers and at least one inner pre-ceramic paper and/or cardboard structure (3, 4) as an intermediate layer and spacer for the outer pre-ceramic paper and/or cardboard structures (1, 2). The inner pre-ceramic paper and/or cardboard structure (3, 4) in the composite is connected on the upper and/or lower face over the entire surface to at least one further pre-ceramic paper- and/or cardboard structure (1, 2) and the inner pre-ceramic paper- and/or cardboard structure (3, 4) has a plurality of surface cut-outs (5, 6).

### BACKGROUND OF THE INVENTION

1. Field of the Invention

The invention relates to a ceramic of pre-ceramic paper structures and/or cardboard structures, especially made for use as ceramic filter material, obtainable from a composite of at least two outer pre-ceramic paper and/or cardboard structures as cover coatings and at least one inner pre-ceramic paper and/or cardboard structure as the intermediate layer and spacer for the outer pre-ceramic paper structures and/or cardboard structures.

2. Description of Related Art

Porous ceramics are used in engineering for numerous applications, for example, as heat insulating structures, combustion aids, porous burner substrates and fire protection structures.

To produce thin-walled structure ceramics, paper and/or cardboard structures can be used as a forming tool. It is known from the prior art that paper and/or cardboard structures are immersed in a slip of metallic or ceramic powders, as a result of which external coating takes place. The correspondingly immersed cardboards and papers are then converted into ceramic formed bodies by way of oxidation and pyrolysis and sinter firing; this is called “ceramicization” below. In this process guidance high temperature-resistant cellular ceramics with comparatively low weight result. Several layers of pre-ceramic paper and/or cardboard structures can be slabbed by lamination, for example, and load-bearing corrugated cardboard structures can be implemented by joining corrugated layers to planar pre-ceramic papers or cardboards. After thermal treatment and sintering, pure ceramic components are formed therefrom. Compared to a solid ceramic of the same thickness, for example, of aluminum oxide, major weight savings are achieved in this way.

International Patent Application Publication WO 2007/042105 A1 and corresponding U.S. Pat. No. 8,048,544 disclose a method for producing a ceramic, fibrous materials and fillers being mixed and processed into a pre-ceramic paper or a cardboard. Then the paper which has been produced in this way or the produced cardboard is exposed to pyrolysis and/or a sintering process. The ceramic which can be obtained in this way is made in the form of a paper and/or cardboard structure which has been reproduced beforehand as a composite ceramic. The fillers can be chosen from the group of carbides, nitrides, oxides, borides and/or zeolites. Fillers can be metals such as iron, nonferrous metals such as copper, nickel, chromium, titanium and their alloys such as bronze, brass or high-grade steel. Fillers can also be especially Al₂O₃, ZrO₂, SiC, Si₃N₄, TiO₂, B₄C, TiC, TiB₂ and/or mixtures thereof and/or glasses such as aluminosilicates. Otherwise, International Patent Application Publication WO 2007/042105 A1 and corresponding U.S. Pat. No. 8,048,544 already disclose using a ceramic of pre-ceramic paper and/or cardboard structures for gas separation or liquid filtration. These ceramic membranes are used in microfiltration, ultrafiltration, and nanofiltration. Here flat, large-area filter constructions are attempted which cannot be implemented by means of conservative methods, for example, extrusion. The advantage of using the ceramic structures under discussion is that large-area, thin ceramic substrates can be produced and can be implemented by paper-making methods in multilayer systems. The thickness of the ceramic substrates is less than 500 μm here for papers, but up to 50 mm for cardboards.

International Patent Application Publications WO 2007/113219 A1 and International Patent Application Publication WO 2005/049524 A1 disclose other methods for producing ceramics from pre-ceramic paper structures and/or cardboard structures.

All technical features of the referenced documents International Patent Application Publications WO 2007/042105 A1 (and corresponding U.S. Pat. No. 8,048,544), WO 2007/113219 A1 and WO 2005/049524 A1 are to belong to the teaching of the invention. The aforementioned documents are to be fully included in the disclosure of the invention. This relates especially to the known methods for producing a ceramic and the parent materials for producing the ceramic.

In ceramics which can be produced by thermal reaction of a composite of several pre-ceramic paper and/or cardboard structures and which can have, for example, a corrugated cardboard structure or similar lightweight structure, the disadvantage is however that the connection between the individual ceramicized layers of the pre-ceramic paper and/or cardboard structures does not ensure permanent coherency and the ceramic does not have sufficient mechanical strength. If, for example, ceramics which have been obtained from pre-ceramic paper and/or cardboard structures with a corrugated cardboard structure are used for filtration of fluids, spalling of parts of the ceramic can occur very easily in backflushing of the filter. The danger of spalling is especially increased when corrosive media are being filtered. Even in other applications, for example, in lightweight buildings and lightweight parts, in which ceramics of pre-ceramic paper and/or cardboard structures are used, spalling of parts of the ceramic can easily occur due to a nonuniform load distribution; this can have an adverse effect on the service life of the ceramic and/or can degrade the serviceability of the ceramic.

European Patent Application EP 1 464 379 A1 corresponding to U.S. Patent Application Publication 2004/195164 and DE 697 31 430 T2 corresponding to U.S. Pat. No. 5,858,229 disclose helically wound membrane filters (helical winding modules) which have jacket-like double filter membranes which are made in a square or a rectangle and have an inner intermediate space, such as for example, a mesh intermediate space to form a channel within the membrane. The membranes are wound around a shaft and are attached to the shaft. The production of the known helically wound membrane filter is complex and expensive.

### SUMMARY OF THE INVENTION

The object of this invention is to make available a ceramic of the initially named type which is characterized by an improved mechanical strength and by a low weight.

This object is achieved in that the composite which is used to produce the ceramic in accordance with the invention from pre-ceramic papers and/or cardboards has at least one inner pre-ceramic paper and/or cardboard structure which on the top and/or bottom is joined in a blanket manner to at least one other pre-ceramic paper and/or cardboard structure and has a plurality of surface openings or perforations or through openings which penetrate the structure transversely to the flat sides and which form cavities or empty spaces in the inner paper structure and/or cardboard structure. In the region of the recesses the inner pre-ceramic paper and/or cardboard structure is not joined to the other pre-ceramic paper structure and/or cardboard structure. The outer pre-ceramic paper and/or cardboard structures as cover coatings preferably have closed flat sides or surfaces. An inner pre-ceramic paper and/or cardboard structure can be joined to at least one outer pre-ceramic paper and/or cardboard structure and/or to at least one further inner pre-ceramic paper structure and/or cardboard structure. Preferably, the inner pre-ceramic paper and/or cardboard structure on both flat sides is joined to one outer pre-ceramic paper and/or cardboard structure at a time. Fundamentally, it is possible to join the paper and/or cardboard structures of the composite to one another by paper-joining techniques (positively or nonpositively) which are known from the prior art, especially by lamination.

The blanket bond between the bordering paper and/or cardboard structures which are joined to one another ensures a high strength of the ceramic in accordance with the invention. The danger of spalling and cracking of parts of ceramic in proper use is thus clearly reduced compared to the ceramics which are known from the prior art. In order to ensure high mechanical strength of the ceramic in accordance with the invention, it is possible to load the composite with a weight during thermal treatment for conversion into the ceramic. In doing so, a high stability of shape of the composite is ensured even at high temperatures and the associated material softening as a result of the blanket bond provided in accordance with the invention between an inner pre-ceramic paper and/or cardboard structure and an outer pre-ceramic paper structure and/or cardboard structure. In particular, the ceramic in accordance with the invention is suitable for use as ceramic filter material, and damage of the ceramic structures can be precluded to a high degree even in the filtration of corrosive media and/or in the backflushing of the filter. Another preferred application of the ceramic in accordance with the invention is in the area of lightweight construction materials, lightweight components with a ceramic in accordance with the invention having a high mechanical strength. The surface openings which are provided in accordance with the invention in the inner pre-ceramic paper and/or cardboard structure at the same time ensures a low weight of the ceramic in accordance with the invention. The size and the distribution of the surface openings are chosen such that the closed areas of the inner pre-ceramic paper and/or cardboard structure are relatively large in order to ensure a relatively high mechanical strength of the composite and thus also the ceramic in accordance with the invention which can be obtained from the composite by thermal treatment in a blanket connection to an outer pre-ceramic paper structure and/or cardboard structure.

The phrase “pre-ceramic paper structure and/or cardboard structure” relates to any paper and/or cardboard structure which can be thermally “ceramicized” or reacted in order to obtain a ceramic structure. A composite of paper and/or cardboard structures or layers can be, for example, immersed into a slip of metallic or ceramic powders and/or can be coated from the outside to produce a ceramic in accordance with the invention. Then, the composite is converted into a ceramic as described above by way of oxidation or pyrolysis and sinter firing. Moreover, for example, it is also possible for the pre-ceramic paper and/or cardboard structures to be obtained from a mixture of fibrous materials and fillers. Moreover, for example, it is possible to obtain pre-ceramic paper layers and/or cardboard layers from a mixture of fibrous materials and fillers.

To produce the ceramic in accordance with the invention, preferably pre-ceramic paper and/or cardboard structures which are planar or which are made flat can be joined to one another as outer and/or inner coatings of the composite. The composite can be formed into a ceramic material before thermal treatment or conversion, and for this purpose paper forming or cardboard forming techniques which are inherently known from the prior art can be used to produce optionally thin-walled structure ceramics of complex shapes. For example, it is possible for the composite to be riffled or corrugated before thermal treatment.

In one preferred embodiment, the ceramic in accordance with the invention is obtained by thermal conversion of a composite which has at least two inner pre-ceramic paper and/or cardboard structures which are joined to one another essentially in a blanket manner between two outer paper structures and/or cardboard structures. Due to the thickness and/or number of the inner pre-ceramic paper and/or cardboard structures used, the distance between the outer cover coatings of the composite, and thus, the thickness of the ceramic in accordance with the invention can be adjusted, if necessary, with respect to the requirements of a particular application. It goes without saying that the ceramic structure in accordance with the invention can also be obtained from a composite of pre-ceramic paper structures and/or cardboard structures, the composite being formed from a plurality of layer orders with at least two outer cover coatings at a time and at least one inner intermediate coating as a spacer for the outer cover coatings. Two adjacent layer orders of the above described type can be separated from one another and can be joined to one another via at least one other intermediate coating.

In a further preferred embodiment of the invention, surface openings in a first inner pre-ceramic paper and/or cardboard structure of the composite and surface openings in a bordering second inner pre-ceramic paper and/or cardboard structure of the composite can be made complementary, and the surface openings in bordering inner pre-ceramic paper and/or cardboard structures can be located on top of one another in regions or can simply overlap in regions. The surface openings of the two inner pre-ceramic paper structures and/or cardboard structures, which recesses overlap or are superimposed, ensure that a relatively large connecting surface between the bordering inner pre-ceramic paper and/or cardboard structures is available in order to achieve a high strength of the composite and thus a high strength of the ceramic in accordance with the invention.

The surface openings can be connected to one another to route a flow. Fundamentally, it is also possible, for example, that the composite has only one inner pre-ceramic paper and/or cardboard structure between two cover coatings with surface openings between two cover coatings, the surface openings being connected to one another and forming at least one flow routing channel which runs essentially in one plane of flow in the ceramic. But preferably there are at least two inner pre-ceramic paper and/or cardboard structures which are joined directly to one another, by the surface openings in one first inner pre-ceramic paper and/or cardboard structure and by the surface openings in a bordering second inner pre-ceramic paper and/or cardboard structure flow routing channels which are connected to one another by ceramicization being formed between the outer cover coatings of the ceramic. The surface openings in the first inner pre-ceramic paper and/or cardboard structure and the surface openings in the bordering second inner pre-ceramic paper and/or cardboard structure lie at different height levels. The ceramic which is obtained from this composite consequently has chambers which are connected to one another, which are located on different flow planes and which lead back to the surface openings of the inner pre-ceramic paper and/or cardboard structures in a region between outer preferably closed ceramic layers, a flow through the ceramic being possible at low flow resistance via the chambers. Preferably the chambers form through flow routing channels which extend over the entire length and/or width of the ceramic in accordance with the invention, and furthermore preferably fluid discharge in the longitudinal direction and in the transverse direction of the ceramic and essentially parallel to the flat sides of the ceramic can be possible.

The flow resistance during flow through the ceramic can be influenced by the size of the surface recesses. In this connection it must however be considered that with increasing size of the surface openings the (total) connecting area available for a connection of the paper and/or cardboard structures to one another drops. Depending on the demands on the mechanical strength of the ceramic in accordance with the invention, thus the size of the surface openings in the paper and/or cardboard structures must be limited. Preferably the proportion of the surface openings of a paper structure or layer and/or cardboard structure or layer relative to the area of the paper structure or layer and/or cardboard structure or layer is between 10 to 90%, preferably between 20% and 80%. The aforementioned ranges comprise all integral intermediate values, even if this is not described in detail.

The thickness of a pre-ceramic paper layer and/or cardboard layer in the green state of the composite, i.e., before the sintering process, can be at least 80 μm, preferably between 100 to 2000 μm, furthermore preferably between 300 and 600 μm, and especially preferably an inner pre-ceramic paper and/or cardboard structure and an outer pre-ceramic paper and/or cardboard structure can have an identical thickness. The aforementioned thicknesses are preferably referenced to a planar pre-ceramic paper layer or structure and/or cardboard layer or structure in the green state, i.e., before conversion into a ceramic. Light ceramics which at the same time have a high strength can be produced by a small thickness of the paper structures and/or cardboard structures. Preferably, to produce the composite, paper and/or cardboard structures are used which have the same thickness. This leads to low process engineering cost in the production of the ceramic in accordance with the invention.

The surface openings in an inner pre-ceramic paper and/or cardboard structure can be arranged regularly distributed. Preferably the surface openings are made circular, elliptical or polygonal. There can also be recesses which are honeycombed, triangular, trapezoidal or square or which are made as slots. Here, the surface openings of at least one inner pre-ceramic paper and/or cardboard structure of the composite can be identically contoured. But it is also fundamentally possible for the surface openings in a paper and/or cardboard structure to be contoured differently. For the sake of simplicity, the surface openings of a first inner pre-ceramic paper and/or cardboard structure and the surface openings of a second inner pre-ceramic paper and/or cardboard structure of the composite can also be made identically contoured. In order to ensure a partial overlapping of the surface recesses, the surface openings in a first inner pre-ceramic paper and/or cardboard structure of the composite can be arranged for example, turned by 90° relative to the surface recess in a bordering second pre-ceramic paper and/or cardboard structure of the composite. In more than two inner pre-ceramic paper and/or cardboard structures which the composite has, there can be a correspondingly changing alignment of the surface recesses. Preferably it is provided that the paper layers and/or cardboard layers form a composite and have identically contoured surface recesses. The individual layers can be turned by 90° relative to one another and/or can be arranged offset relative to one another in order to create partial overlapping of the surface openings of paper layers and/or cardboard layers which are connected to one another. The surface openings in a paper layer and/or a cardboard layer can preferably be obtained by punching of the paper layer and/or cardboard layer. The proportion of the surface openings in a paper layer and/or a cardboard layer in the total area of the paper layer and/or cardboard layer can be roughly 20 to 80%, preferably roughly 30 to 70%.

In an alternative embodiment of the invention, it can also be provided that the individual surface openings and/or the total area of the recessed areas of a first inner pre-ceramic paper and/or cardboard structure are smaller than the surface openings and/or the total area of the recessed areas of a bordering second inner pre-ceramic paper structure and/or cardboard structure. Here a plurality of surface openings of a first inner pre-ceramic paper and/or cardboard structure can be connected to an individual surface recess or several surface openings of a second inner pre-ceramic paper and/or cardboard structure to route the flow. The above described arrangement and execution of the surface openings of at least two bordering inner pre-ceramic paper and/or cardboard structures as an intermediate coating or spacer in a composite with two outer pre-ceramic paper and/or cardboard structures as cover coatings are characterized by a relatively large connecting area between the paper and/or cardboard structures and thus by permanent coherence at a low flow resistance.

The invention also relates to a filter with at least one ceramic filter body as the filter element, the ceramic filter body being obtained by ceramicization of a multilayer composite of flat pre-ceramic paper layers and/or cardboard layers.

As noted above, the object of this invention it to make available a filter of the initially mentioned type which is characterized by an improved mechanical strength and by a low weight and in accordance with a further object which also can be easily produced at low cost.

The aforementioned object is achieved in accordance with the invention in a filter in which the composite has at least one separating layer arrangement with at least one separating layer of a pre-ceramic paper material and/or cardboard material and at least one intermediate layer which is connected to the separating layer and which is composed of a pre-ceramic paper material and/or cardboard material as a spacer for the separating layer, the separating layer forming a separating coating when the composite is ceramicized and the at least one intermediate layer forming an intermediate coating and through-flow zone in the ceramic filter body, the separating layer on the flat sides being closed and the intermediate layer having a plurality of surface openings and being connected in a blanket manner on the top or bottom to the separating layer. The composite can preferably have at least one separating layer arrangement with at least two separating layers of a pre-ceramic paper material and/or cardboard material and at least one intermediate layer which is located between the separating layers and which is composed of a pre-ceramic paper material and/or cardboard material as the spacer for the separating layers, the separating layers forming separating coatings when the composite is ceramicized and the at least one intermediate layer forming an intermediate coating (spacer coating) and through-flow zone between two separating coatings in the ceramic filter body, the separating layers being closed on the flat sides and the intermediate layer having a plurality of surface openings and in the composite being joined in a blanket manner to at least one bordering pre-ceramic paper layer and/or cardboard layer on the top and/or bottom. The structure of the separating layer arrangement in the above described composite during ceramicization of the composite is depicted as a double separating coating arrangement in the ceramic filter body, the separating coatings which are lying next to one another enabling filtration of a liquid, gaseous or vapor medium.

Fundamentally, it is also possible for so-called “lost cores” to be used for the production of filters. The composite then has at least one separating layer arrangement with at least one separating layer of a pre-ceramic paper material and/or cardboard material. On one outer side, preferably on the permeate side of the ceramic filter body which can be obtained by ceramicization of the composite, the separating layer can be joined to an intermediate layer of a pre-ceramic paper material and/or cardboard material as a spacer. When the composite is ceramicized the intermediate layer on the permeate side forms an intermediate coating and a through-flow zone for the permeate flow. On the other outer side, preferably the feed side, the separating layer in the composite can be joined to a paper material and/or cardboard material which cannot be ceramicized and/or a cellular fabric or material which cannot be ceramicized and which burns when the composite is ceramicized, so that, for example, between the two adjacent separating layers a cavity is formed which causes only little flow resistance when flow takes place through it. On the permeate or filtrate side, conversely, an intermediate coating with a perforated structure or the like can be formed by ceramicization of the intermediate layer of the pre-ceramic paper material and/or cardboard material.

A high strength of the formed ceramic body is ensured by a composite which covers the entire surface with reference to the flat sides between bordering pre-ceramic paper layers and/or cardboard layers in the filter in accordance with the invention. The risk of spalling or cracking of parts of the ceramic in proper use is thus greatly reduced compared to the ceramic filters which are known from the prior art with for example, a corrugated cardboard structure. Damage to the formed ceramic body can be largely precluded even in filtration of corrosive media and/or when backflushing the filter.

Preferably, an intermediate layer in the composite on both flat sides is connected in a blanket manner to another pre-ceramic paper layer and/or cardboard layer; this can take place for example, by lamination. Fundamentally, it is possible in this case to join the paper layers and/or cardboard layers of the composite to one another before the sintering process by paper joining techniques (positively and nonpositively) known from the prior art.

Interconnected voids and cavities can be formed by the surface openings or perforations in the intermediate layer(s) and they form channels between bordering pre-ceramic paper layers and/or cardboard layers and during ceramicization they are preserved as through-flow zones or fluid channels in an intermediate coating between bordering (separating) coatings and enable directed flow through the ceramic filter body preferably in the direction of the flat sides of the intermediate coating. Transport of a medium to be filtered to one or more separating coatings on the feed side and the discharge of a permeate flow from the separating coating(s) on the permeate side at low flow resistance are possible via through-flow zones in at least one intermediate coating. On the feed side through-flow zones can also be formed by lost cores of the composite, as described above. The surface openings of the intermediate layer which are provided in accordance with the invention at the same time yield a low weight of the ceramic filter body. The surface openings are preferably obtained by blanking dies or by punching of flat paper layers and/or cardboard layers before they are joined.

In order to ensure a high mechanical strength of the formed ceramic body, it is possible to load the composite with a weight during thermal treatment for conversion into a ceramic. High stability of shape of the composite even at high temperatures and the associated material softening is ensured as a result of the blanket bond provided in accordance with the invention between the pre-ceramic paper layers and/or cardboard layers.

The expression “pre-ceramic paper material and/or cardboard material” relates to any paper and/or cardboard structure which can be converted into a ceramic structure as described above.

A paper material and/or cardboard material can be coated in particular with a ceramicizable material after corresponding forming in order to first apply a smoothing coating or equalization coating to the paper material and/or cardboard material. Then a first sintering process takes place in which the paper material and/or cardboard material is burned and a ceramic support body is formed which is then coated again with a ceramicizable material. Another sintering process then follows. In this way very small pore diameters of a separating coating can be established or dictated in a controlled manner by repeated coating and sintering. In order to achieve a small pore size of a separating coating, there can also be repeated coating and sintering of a separating layer or a support body which can be obtained from it only on one feed side.

Preferably pre-ceramic paper layers and/or cardboard layers which are planar or which have been made flat can be connected to one another and can form outer coatings (separating layers) and/or inner coatings (intermediate layers) of the composite. The composite can then be formed before thermal treatment or before ceramicization by sintering, and for this purpose paper and cardboard forming techniques which are known from the prior art can be used in order to produce for example, thin-walled structure ceramics of complex shape. In particular it is possible for the layers to be helically wound before the thermal treatment and for the composite to be ceramicized in the wound helical state of the layers.

The flow resistance during flow through an intermediate layer of the ceramic filter body can be influenced via the size of the surface openings or openings in an intermediate layer. In this connection it must however be considered that with increasing size of the surface openings the remaining surface which is available for blanket connection of the bordering paper layers and/or cardboard layers decreases. Depending on the demands on the mechanical strength of the ceramic filter body, the size of the surface openings thus can be fixed.

The thickness of, for example, aplanar pre-ceramic paper layer and/or cardboard layer in the green state of the composite, i.e., before the sintering process, can be at least 80 μm, preferably 300 to 400 μm. The maximum paper thickness of a (planar) paper layer and/or cardboard paper layer in the green state can be preferably between 1.0 mm to 1.5 mm. But the prior art also discloses papermaking machines which first produce two or more layers separately and then join them within the machine (lamination) so that a web composed of several layers is formed with a corresponding thickness which can correspond to a multiple of the thickness of one layer of the paper material and/or cardboard material in the green state. The shrinkage in the sintering process can be fundamentally between 20 to 30%. Depending on the material used, the shrinkage can also be between 10 to 40% in the sintering process.

To produce the composite, paper layers and/or cardboard layers can be used which have a uniform thickness. This contributes to low production cost of the filter in accordance with the invention. Preferably, the pre-ceramic paper materials and/or cardboard materials which form a separating layer, and the pre-ceramic paper materials and/or cardboard materials which form an intermediate layer however have a different thickness. The separating layer should be as thin as possible in order to ensure a low flow resistance in passage through the separating coating. The intermediate layer can be made accordingly thicker in order to create a relatively large through-flow zone with low flow resistance. This applies especially to an intermediate coating and through-flow zone on the feed side of the separating coating.

The surface openings in an intermediate layer can be arranged regularly distributed over the area. Preferably, the surface openings are made circular, elliptical or polygonal. There can also be recesses which are honeycombed, triangular, trapezoidal or square or which are made as slots. Preferably, all surface openings in an intermediate layer are identically contoured. The proportion of the surface openings in an intermediate layer in the total area of the intermediate layer can be roughly 20 to 80%, preferably roughly 30 to 70%.

In one preferred embodiment of the invention, it is provided that the composite which is used to produce the ceramic filter body has a plurality of separating layer arrangements which lie next to one another—each formed by at least two separating layers and at least one intermediate layer between the two separating layers—which are joined via at least one other intermediate layer which is located between the separating layer arrangements and which is composed of a pre-ceramic paper material and/or cardboard material as a spacer for the separating layer arrangements. As already described above, it can also be provided that a separating layer arrangement is formed by two separating layers and at least one intermediate layer between the two separating layers, two adjacent separating layer arrangements being joined by a paper material and/or cardboard material which cannot be ceramicized, i.e., a material which burns in the sintering process. Two separating layer arrangements can thus be connected to one another by a lost core. Then, a cavity in the ceramic filter body which can be provided preferably for a feed line forms in the sintering process between two separating layer arrangements.

An intermediate layer of a pre-ceramic paper material and/or cardboard material can have a plurality of surface openings and can be connected on the top and/or bottom in a blanket manner to a bordering pre-ceramic paper layer and/or cardboard layer. When the composite is ceramicized this intermediate layer then forms an intermediate coating of the ceramic filter body, for example, a drainage coating for discharge of permeate from adjacent separating coatings.

A medium which is to be filtered can be supplied via first intermediate coatings to an adjacent separating coating and a permeate flow which is passing through the separating coating can be discharged via a second intermediate coating. In this connection it is possible and is preferably provided that flow takes place through first and second intermediate coatings in filtration in different flow directions which are arranged preferably turned 90° relative to one another so that cross-flow filtration is possible.

A certain flow direction in an intermediate coating can be dictated by the structure of the pre-ceramic intermediate layers which form an intermediate coating when the composite is ceramicized. The term “structure” of a pre-ceramic paper layer and/or cardboard layer in the sense of the invention can be referenced to a certain number, geometry, size and distribution as well as alignment of the surface openings in a paper layer and/or cardboard layer.

Between at least two separating layers of the composite, preferably, there are at least two intermediate layers which are connected flat to one another so that an at least four-ply separating layer arrangement with outer separating layers and inner intermediate layers is obtained. Preferably, the intermediate layers which are directly connected to one another have surface openings or openings which overlap only in regions and which are made complementary to one another. In this way, on the one hand, a high strength of the ceramic filter body can be achieved. A larger number of intermediate layers in the composite and/or use of intermediate layers with greater thickness can, if necessary, further increase the strength of the ceramic filter body. The overlapping surface openings of intermediate layers which are connected to one another form cavities or voids and channels which are connected to one another between the separating layers which are preserved when the composite is ceramicized and in the ceramic filter body enable a fluid transport within the intermediate coatings of the filter which are formed from the intermediate layers preferably in the direction of the flat sides of the intermediate coatings. Depending on the number, geometry, size and distribution as well as the alignment of the overlapping surface recesses, the size and number of the fluid channels in the intermediate coatings can be changed and thus the flow resistance can be influenced and a certain flow direction can be induced.

To ensure that the surface openings of interconnected identical intermediate layers overlap only in regions, adjacent intermediate layers can be aligned, for example, turned by 90° relative to one another. However, it is preferably provided that interconnected intermediate layers are structured differently. For example, it can be provided that the surface openings of a first intermediate layer are smaller and/or have a different geometry than the surface openings of a bordering second intermediate layer. Connected intermediate layers can have the same or a different thickness.

Preferably, the ceramic filter body has a collecting channel which runs in the region of the center longitudinal axis for permeate or for a medium which is to be filtered, and separating coatings and intermediate coatings can be arranged distributed over the periphery of the collecting channel, preferably arranged helically around the collecting channel. In order to enable discharge of the permeate from the separating coatings, or to enable supplying of the medium to the separating coatings, the collecting channel is connected to at least one intermediate coating to route the flow. Preferably, the ceramic filter body has, in alternation, first and second intermediate coatings, the first intermediate coatings being connected to the collecting channel to route fluid and the second intermediate coatings not being fluid-connected to the collecting channel. In this way, the filter separating task can be ensured and mixing of permeate and a fluid or retentate to be filtered can be precluded.

The composite can have a tubular body of a pre-ceramic paper material and/or cardboard material, the separating layers and the intermediate layers being arranged distributed over the periphery of the tubular body and being attached to the tubular body. When the composite is ceramicized, the tubular body forms a tubular region of the ceramic filter body which borders a collecting channel for a permeate flow or a fluid which is to be filtered and a flow of retentate. In order to be able to discharge permeate from the separating coatings via the collecting channel or to be able to feed a fluid to the separating coatings, it is necessary that at least one intermediate coating is connected to the collecting channel to route fluid. To do this, it can be provided that cavities, voids and channels which are formed by surface openings or openings in connected intermediate layers are connected to the interior of the tubular body via openings in the tubular body.

To the extent the tubular body and the separating and intermediate layers which are connected to the tubular body consist of an identical pre-ceramic paper material and/or cardboard material, the composite has a comparable shrinkage behavior in all regions during heat treatment and ceramicization. The stresses which occur in the shrinkage process are therefore low; this contributes to a high strength of the ceramic filter body.

In one alternative embodiment of the invention, it can be provided that the composite has a tubular base body, the separating layers and the intermediate layers being arranged distributed over the periphery of the green body and being attached to the green body. For this purpose it can be provided that cavities, voids and channels which are formed by surface openings or openings in connected intermediate layers are connected to the interior of the green body via openings in the green body. The green body and the separating and intermediate layers are sintered jointly. Based on the different shrinkage behavior, the attachment of the paper layers and/or cardboard layers to the green body acquires special importance.

Finally, it is also possible for the separating layers and the intermediate layers in the composite to be arranged helically around a cylindrical cavity. The pre-ceramic paper layers and/or cardboard layers can be wound for example, around a rod or the like before ceramicization so that after removing the rod a middle cylindrical cavity results and forms the collecting channel after ceramicization of the composite. For sealing purposes, on the ends of the collecting channel there are stoppers or the like which are inserted and sealed into the collecting channel. It can also be provided here that in the composite, cavities, voids and channels which are formed by surface openings or openings of connected intermediate layers are connected to the interior of the tubular body of the cavity in order to enable liquid transport in the ceramic filter body via the intermediate coatings and the collecting channel.

To achieve the initially named object, therefore a filter with a ceramic filter body as a filter element is proposed; the ceramic filter body being obtainable by ceramicization of a composite of several helically wound flat pre-ceramic paper layers and/or cardboard layers. Preferably the ceramic filter body can be obtained by ceramicization of a composite of the above described type and/or has features of the above described ceramic filter body. In accordance with the invention, for the first time paper and/or cardboard structures are used as a forming tool for making ceramic filter bodies with helically arranged separating coatings and intermediate coatings; this allows simple and economical production of the filter in accordance with the invention.

The aforementioned aspects and features of this invention and the aspects and features of this invention which are described below using the drawings can be implemented independently of one another, in any combination, but also in conjunction with the features of the preamble of the independent claims of this invention even if this is not described in particular. Here inherently inventive importance can be assigned to each described feature or aspect. In particular the invention makes it possible to provide features of the ceramic and filter in accordance with the invention.

Other advantages, features, properties and aspects of this invention will become apparent from the following description of a preferred embodiment together with the drawings.

### BRIEF DESCRIPTION OF THE DRAWINGS

FIG. 1 schematically show two outer pre-ceramic paper and/or cardboard structures and two inner pre-ceramic paper and/or cardboard structures combined into a composite intended for production of a ceramic in accordance with the invention,

FIGS. 2 to 9 show alternative possibilities for the arrangement and execution or configuration of surface openings in the inner pre-ceramic paper and/or cardboard structures from FIG. 1,

FIG. 10 shows a schematic of a composite with several pre-ceramic paper layers and/or cardboard layers for producing a ceramic filter body by ceramicization of the composite,

FIG. 11 shows a schematic of a filter in accordance with the invention with a ceramic filter body, the ceramic filter body being obtainable by ceramicization of a composite of several helically wound flat pre-ceramic paper layers and/or cardboard layers, in a perspective view obliquely from the side,

FIG. 12 shows a schematic plan view of a composite with a middle tubular body and several separating and intermediate layers which are arranged distributed over the periphery of the tubular body, and the type of winding of the separating and intermediate layers,

FIG. 13 shows a schematic plan view of several separating layers and intermediate layers of a composite of pre-ceramic paper layers and/or cardboard layers, the separating layers and the intermediate layers bordering a cylindrical cavity, and the type of winding of the separating and intermediate layers,

FIG. 14 shows a schematic of a composite with two outer separating layers of a pre-ceramic paper material and/or cardboard material and two intermediate layers which are located between the separating layers and which are composed of a pre-ceramic paper material and/or cardboard material as a spacer for the separating layers, the inner intermediate layers having partially overlapping surface recesses, and

FIGS. 15 to 22 show alternative possibilities for the arrangement and execution or configuration of surface openings in the intermediate layers from FIG. 14.

### DETAILED DESCRIPTION OF THE INVENTION

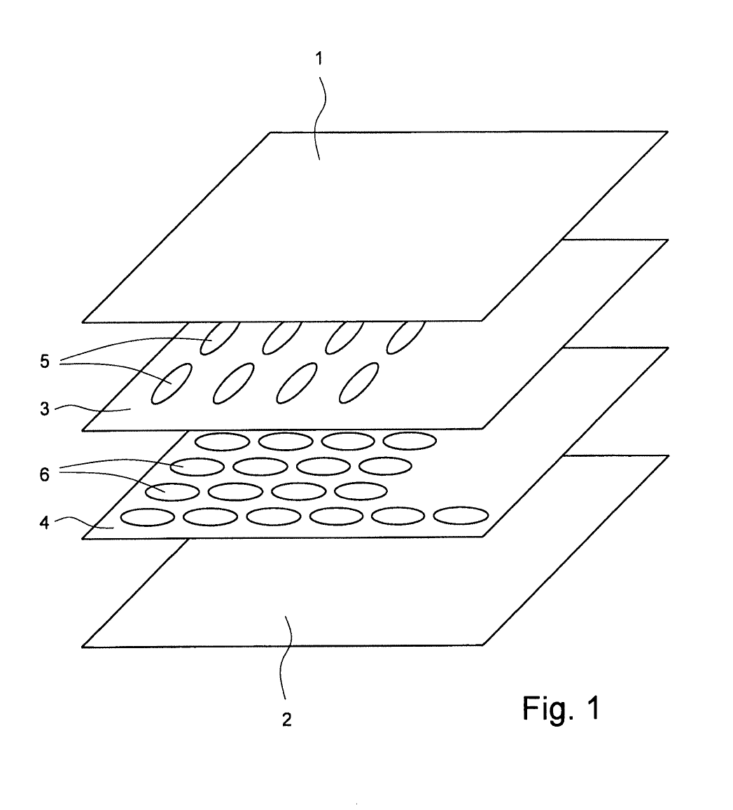

FIG. 1 shows an arrangement with two outer pre-ceramic paper and/or cardboard structures 1, 2 and with two inner pre-ceramic paper and/or cardboard structures 3, 4, that can be joined into a composite, especially by lamination and/or cementing. In the composite, the two outer pre-ceramic paper and/or cardboard structures 1, 2 form outer cover coatings and the two inner pre-ceramic paper and/or cardboard structures 3, 4 form an intermediate coating or a spacer for the outer pre-ceramic paper and/or cardboard structures 1, 2. A ceramic can be produced in the manner known from the prior art from the pre-ceramic paper and/or cardboard structures 1-4 by thermal conversion of the paper and/or cardboard structures.

According to FIG. 1, the paper and/or cardboard structures 1-4 are made flat or planar; this facilitates molded connection of the paper and/or cardboard structures 1-4 to one another and ensures a high strength of the composite, and thus, of the ceramic which can be obtained from it. It is possible for the composite formed by the joined paper and/or cardboard structures 1-4 to be subjected to a forming method in order to obtain a certain shape of the ceramic which is reproduced in the composite structure.

As follows further from FIG. 1, the inner pre-ceramic paper and/or cardboard structures 3, 4 have a plurality of surface openings 5, 6 which are arranged regularly according to FIG. 1 and which can have the same size and shape. On the one hand, a low weight of the composite which can be obtained from the paper and/or cardboard structures 1-4 and thus of the ceramic which can be obtained is achieved by the surface openings 5, 6. The surface openings 5 of the inner pre-ceramic paper and/or cardboard structure 3 and the surface openings 6 of the inner pre-ceramic paper and/or cardboard structure 4 are aligned or oriented turned by 90° relative to one another.

When the pre-ceramic paper and/or cardboard structures 1-4 are joined, the closed areas of the inner pre-ceramic paper and/or cardboard structures 3, 4 are cemented to one another and to the outer pre-ceramic paper and/or cardboard structures 1, 2 so that a high strength of the composite, and thus, of the ceramic which can be obtained from the composite, is achieved. The number of the inner pre-ceramic paper and/or cardboard structures 3, 4 can be chosen at will in order to achieve a certain distance between the outer pre-ceramic paper and/or cardboard structures 1, 2, and thus, a certain thickness of the composite. Several arrangements of interconnected paper layers and/or cardboard layers of the type shown in FIG. 1 can also be connected to one another, preferably via at least one other inner pre-ceramic paper and/or cardboard structure 3, 4. Otherwise, an arrangement of the type under consideration can also have several outer pre-ceramic paper and/or cardboard structures 1, 2 which are connected directly to one another.

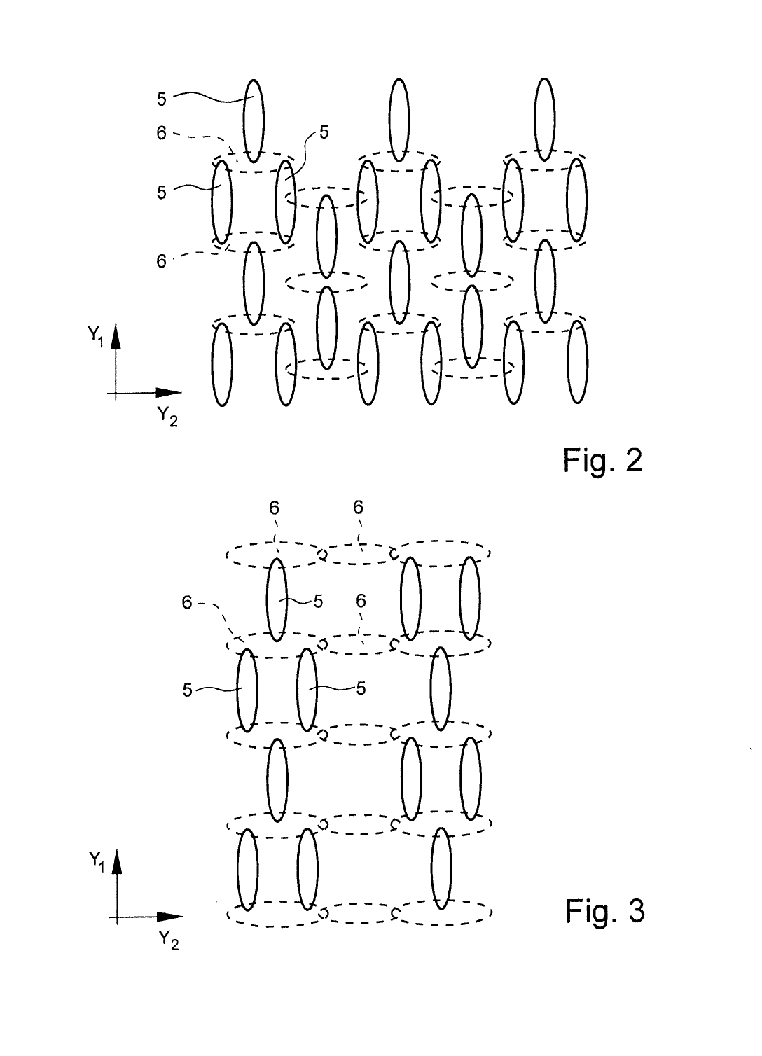

As follows from FIGS. 2 to 8, surface openings 5 in a first inner pre-ceramic paper and/or cardboard structure 3 and surface openings 6 in an adjacent second inner pre-ceramic paper and/or cardboard structure 4 can be made complementary and can be arranged on top of one another in areas in the composite of the pre-ceramic paper and/or cardboard structures 1-4 according to FIG. 1. The partially overlapping surface openings 5, 6 form flow guide channels which are connected to one another in the ceramic which can be obtained from the composite. Preferably, here, it is such that a directed flow through the ceramic in at least two directions of space Y₁, Y₂ is possible. The surface openings 5 of a first inner pre-ceramic paper and/or cardboard structure 3 according to FIG. 2 and FIG. 3 extend in the flow direction Y₁, while the surface openings 6 of a bordering inner pre-ceramic paper and/or cardboard structure 4 extend transversely thereto in the flow direction Y₂. The surface openings 5 are connected to one another via surface openings 6 which run transversely thereto and vice versa.

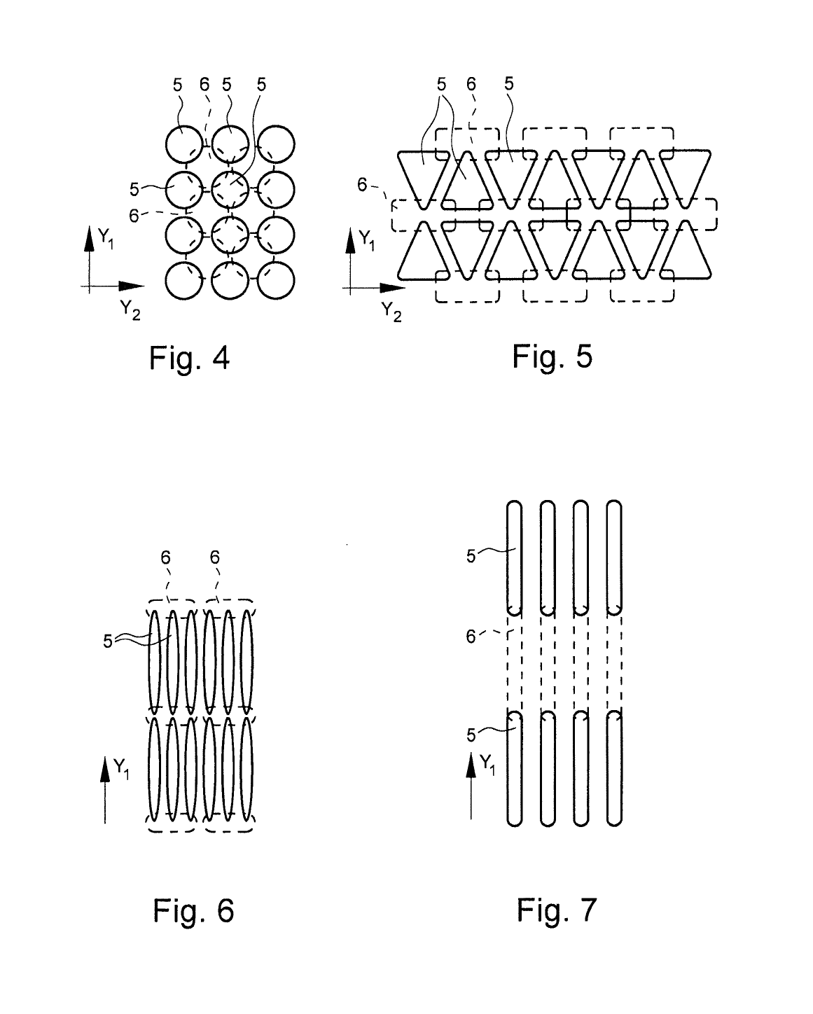

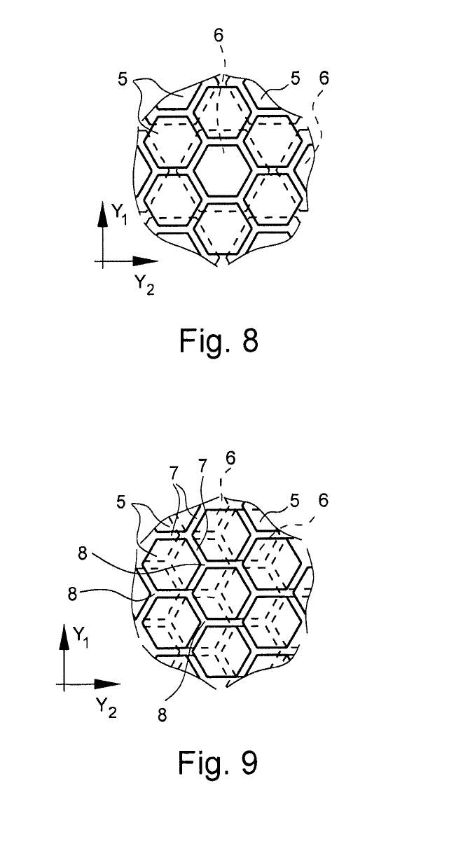

As follows from FIGS. 2 to 8, the surface openings 5, 6 in an inner pre-ceramic paper and/or cardboard structure 3, 4 can be arranged regularly distributed. According to FIGS. 2, 3 and 6 the surface openings 5, 6 are made elongated and elliptical. According to FIG. 7, the surface openings 5, 6 are made as slots. According to FIG. 4, the recesses 5, 6 can also be circular. According to FIGS. 5 and 8 the recesses 5, 6 can also be rectangular, triangular, hexagonal or honeycombed. Additionally, the surface openings 5, 6, fundamentally, also can have another polygonal shape.

The embodiment shown in FIG. 5 with triangular surface openings 5 of a first inner pre-ceramic paper and/or cardboard structure 3 and with rectangular surface openings 6 of a second inner pre-ceramic paper and/or cardboard structure 4 which are arranged in alternation as well as the embodiment shown in FIG. 8 with honeycombed surface openings 5, 6 are characterized for correspondingly larger through-flow openings by a comparatively small total connecting area between the pre-ceramic paper and/or cardboard structures 1-4.

Moreover, all surface openings 5, 6 of an inner pre-ceramic paper and/or cardboard structure 3, 4 are preferably identically contoured. In the embodiments which are shown in FIGS. 2 and 3, the surface openings 5 of a first inner pre-ceramic paper and/or cardboard structure 3 and the surface openings 6 of a second inner pre-ceramic paper and/or cardboard structure 4 are identically contoured. The same applies to the embodiment shown in FIG. 7.

As follows from FIGS. 4, 5, 6 and 8, the surface openings 5, 6 of the interconnected pre-ceramic paper and/or cardboard structures 3, 4 can also be contoured differently, in particular they can have a different size. For example, in the embodiments shown in FIGS. 4 and 8, the surface openings 5 of a first inner pre-ceramic paper and/or cardboard structure 3 are of the same shape but are smaller than the surface openings 6 of a bordering second inner pre-ceramic paper and/or cardboard structure 4. Here, a plurality of surface openings 5 of a first inner pre-ceramic paper and/or cardboard structure 3 can be connected to a larger surface recess 6 of a second inner pre-ceramic paper and/or cardboard structure 4 to route the flow.

According to the embodiments which are shown in FIGS. 6 and 7, flow through the ceramic which can be obtained from the composite is also possible only in one flow direction Y₁. According to FIG. 6, this flow routing is achieved via a plurality of surface openings 5 of a first pre-ceramic paper layer and/or cardboard layer 3 which extend in the flow direction Y₁ and make contact with one another via surface openings 6 of a second pre-ceramic paper layer and/or cardboard layer which are located transversely to the flow direction. According to FIG. 7, all surface openings 5, 6 extend in the flow direction Y₁, overflow transversely to the flow direction Y₁ not being possible since the surface openings 6 are not connected to one another to route fluid transversely to the through-flow direction Y₁.

FIG. 9 shows a preferred embodiment in which the surface openings 5, 6 of two inner pre-ceramic paper and/or cardboard structures 3, 4 that are connected to one another have the same contour. The paper and/or cardboard structure 3, 4 have a honeycomb, lattice-shaped or net-like structure with crosspieces 7 which run together at connecting sites 8. Hexagonal surface openings 5, 6 are bordered by crosspieces 7 which are connected to one another. The connected paper and/or cardboard structures 3, 4 can be arranged offset or turned relative to one another. Preferably, the paper and/or cardboard structures 3, 4 are arranged offset relative to one another such that connecting sites 8 of a first inner paper and/or cardboard structure 3 are located above the hexagonal surface openings 6 of an underlying second inner paper and/or cardboard structure 4. In this way, a very low flow resistance is ensured when flow takes place through the ceramic which can be obtained from the paper and/or cardboard structures 3, 4.

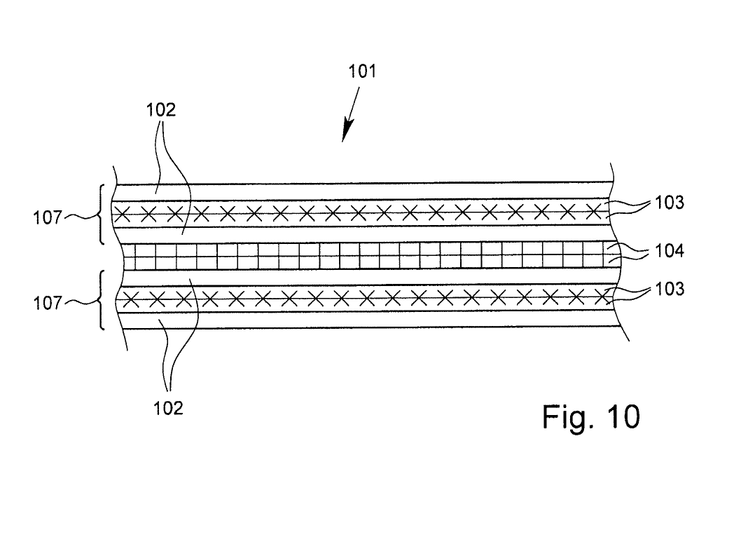

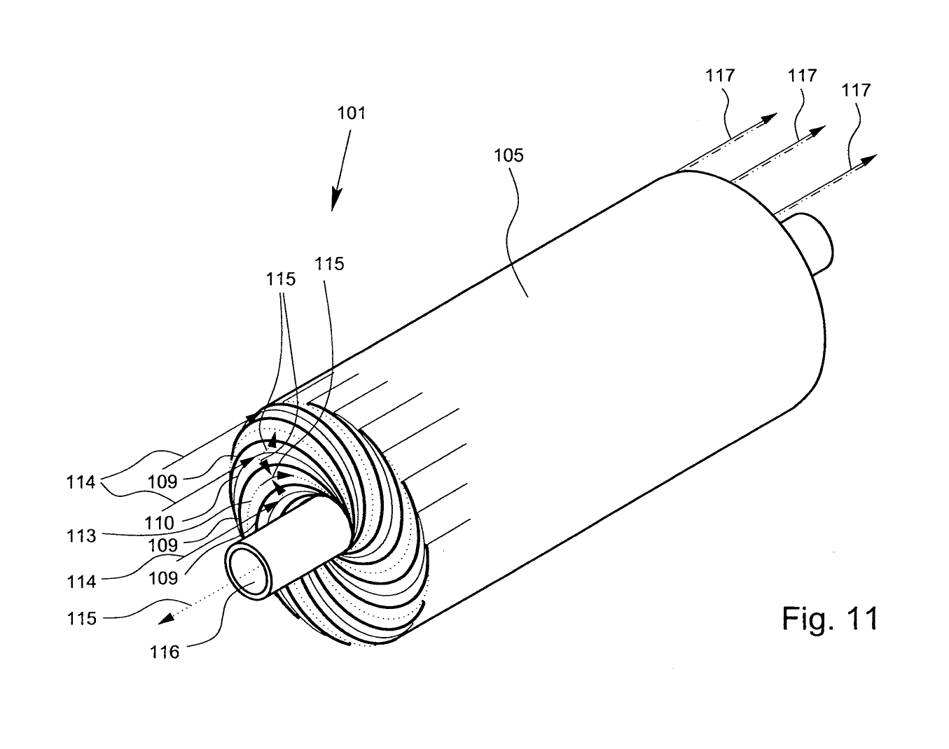

FIG. 10 schematically shows the structure of a composite 101 with several pre-ceramic paper layers and/or cardboard layers 102 through 104, ceramicization of the composite 101 yielding a ceramic filter body 105 of a filter 106 which is shown in FIG. 11. The composite 101 has several separating layer arrangements 107, each separating layer arrangement 107 being formed by two separating layers 102, and here, two intermediate layers 103 which are located between the outer separating layers 102 as spacers for the outer separating layers 102. When the composite 101 is ceramicized, the separating layers 102 form separating coatings 109 and the intermediate layers 103 between two separating layers 102 each form one common intermediate coating 110 (spacer coating) and through-flow zone between two adjacent separating coatings 109 in the ceramic filter body 105.

As follows further from FIG. 10, the composite 101 has a plurality of separating layer arrangements 107 which lie next to one another and which are connected to one another by way of two other intermediate layers 104 which are located between the separating layer arrangements 107 as spacers for the separating layer arrangements 107. The other intermediate layers 104 form another intermediate coating 113 (drainage coating) in the ceramic filter body 105 during ceramicization.

It is also pointed out that the composite 101 can also have more than two intermediate layers 103, 104 between two adjacent separating layers 102 and/or several separating layers 102 which are directly connected to one another. The intermediate layers 103, 104 which are directly connected to one another can be made or structured the same or differently and/or can have an identical or different thickness.

In the illustrated embodiment, it is provided that the separating layers 102 have a closed surface and the intermediate layers 103, 104 each have a plurality of surface openings 111, 112 or openings, the intermediate layers 103, 104 being connected to one another in a blanket manner in the composite 101 on the top and/or bottom to at least one bordering separating layer 102 and/or one bordering intermediate layer 103, 104. In this way a high strength of the ceramic filter body 105 which can be obtained by ceramicization of the composite 101 results.

Two interconnected intermediate layers 103, 104 preferably have surface openings 111, 112 which overlap in areas and which are made complementary to one another for forming connected cavities, voids and channels between two separating layers 102. During ceramicization, these cavities, voids and channels are preserved and create a through-flow zone in an intermediate coating 110, 113 of the ceramic filter body 105. This is explained in more detail below in conjunction with FIG. 11.

In particular, it can be provided that the intermediate layers 103 of one separating layer arrangement 107, on the one hand, and the intermediate layers 104 between two separating layer arrangements 107, on the other, have a different number, geometry, size and distribution as well as alignment of the surface openings 111, 112 and/or a different thickness. It is also possible for the number of intermediate layers 103 between two separating layers 102 of a separating layer arrangement 107 and the number of intermediate layers 104 between two adjacent separating layer arrangements 107 to be different.

FIG. 11 shows a filter 101 with a ceramic filter body 105 as a filter element, the ceramic filter body 105 being obtainable, for example, by ceramicization of a composite 101 of the type described in FIG. 10. The ceramic filter body 105 has several separating coatings 109 which are separated from one another via intermediate coatings 110 and further intermediate coatings 113. The separating coatings 109 and the intermediate coatings 110, 113 are arranged helically around the collecting channel 116.

Two adjacent intermediate coatings 110, 113 are each separated from one another by a separating coating 109 and flow through them takes place in a crossflow. A fluid 114 to be filtered on one face side enters the ceramic filter body 105 and flows through the intermediate coatings 110 in an axial direction. The intermediate coatings 110 are used as spacer coatings and provide for an effective overflow and optimum swirling of the fluid 114 on the inner surface of the separating coatings 109. In this way, the formation of a cover coating on the separating coatings 109 is reduced. As a result of a pressure difference, a permeate flow 115 permeates through the separating coatings 109 which border the intermediate coatings 110 into the other intermediate coatings 113 which, as drainage coatings, provide for the permeate flow 115 to be routed to the collecting channel 116 and drained via the collecting channel 116. The intermediate layers 113 are connected to the collecting channel 116 to route the flow for this purpose.

The intermediate layers 110 can also be obtained by a composite, which on the respective feed side of the separating layers 102, has lost cores which are made of a nonceramicizble paper material and/or cardboard material or cellular fabric or material which burns when the composite is ceramicized, so that the intermediate coatings 110 are made as cavities between adjacent separating coatings 109. In this way, a very low pressure loss can be ensured in flow through the filter.

The peripheral surface of the ceramic filter body 105 is preferably made closed so that the permeate cannot escape here. This can be achieved by a corresponding coating of the jacket surface of the ceramic filter body 105. On the other face side, a retentate flow 117 emerges from the ceramic filter body 105.

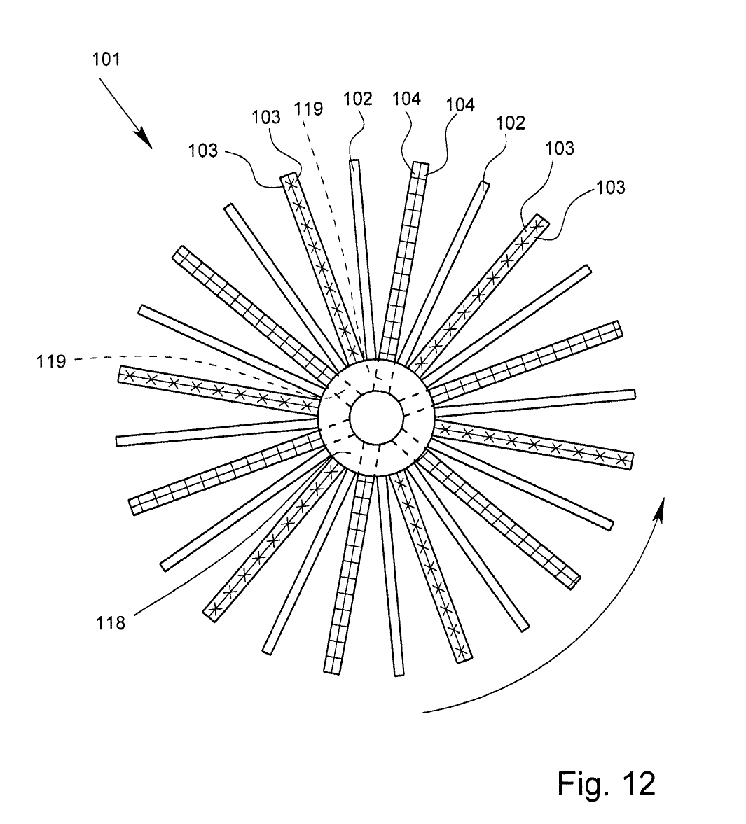

FIG. 12 shows a composite 101 with a tubular body 118 which likewise is formed from a pre-ceramic paper material and/or cardboard material. During ceramicization, the tubular body 118 forms a tubular region of the ceramic filter body 105 which borders the collecting channel 116 of the ceramic filter body 105. The separating layers 102 and the intermediate layers 103, 104 are wound helically around the tubular body 118 and are ceramicized together with the tubular body 118 so that a ceramic filter body 105 with separating coatings 109 and intermediate coatings 110, 113 which run helically is obtained.

The separating layers 102 and the intermediate layers 103, 104 are arranged distributed in a star shape over the periphery of the tubular body 118 in the composite 101 and are attached to the tubular body 118. The intermediate layers 104 in the region of openings 119 of the tubular body 118 are connected to the latter, cavities, voids, and channels in the intermediate layers 104 being in an open connection to the interior of the tubular body 118 via the openings 119. The discharge of the permeate or the supply of a fluid is enabled in this way via the intermediate coatings 113 (drainage coatings) which are formed from the intermediate layers 104 and via the collecting channel 116 of the ceramic filter body 105.

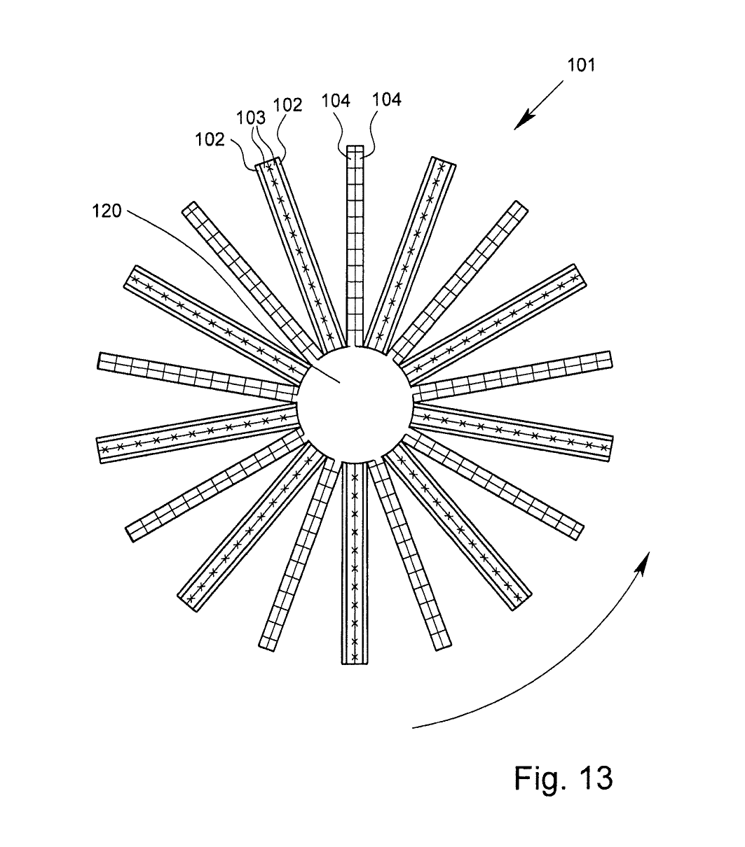

FIG. 13 shows another embodiment of a composite 101, the separating layers 102 and the intermediate layers 103, 104 in the composite 101 being arranged in a star shape around a cylindrical cavity 120. The cavity 120 can be formed by helical winding of the separating layers 102 and the intermediate layers 103, 104 on a rod which is pulled out of the composite 101 before ceramicization. The separating layers 102 and the intermediate layers 103, 104 are laterally connected to one another on the ends facing one another so that an essentially closed cavity 120 is created. Here, a fluid exchange is also possible between the intermediate coatings 113 of the ceramic filter body 105 which are formed from the intermediate layers 104 when the composite 101 is ceramicized, and a collecting channel 116 which is formed from the cavity 120.

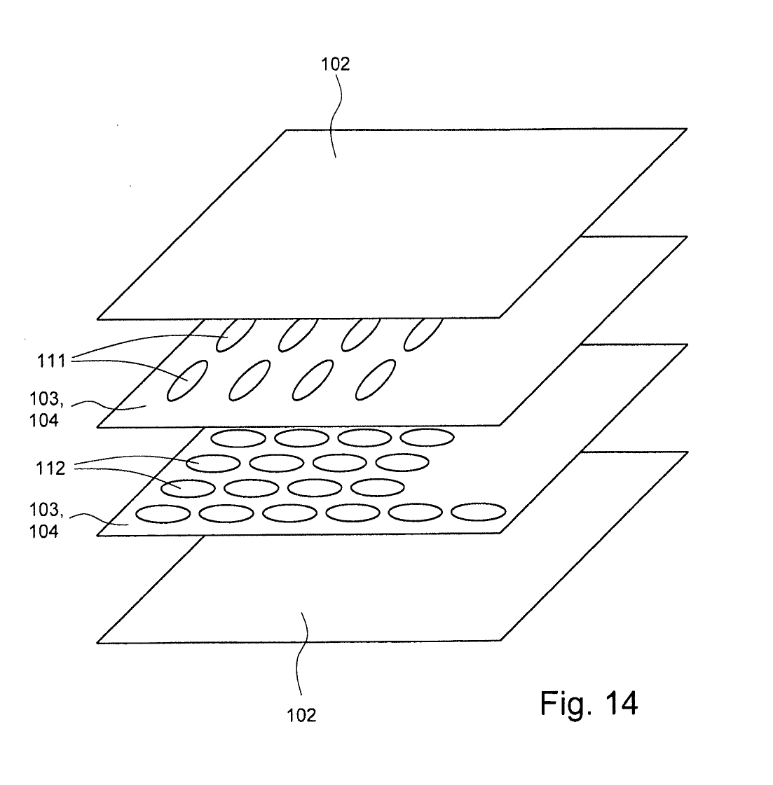

FIG. 14 shows an arrangement with two outer separating layers 102 of a pre-ceramic paper and/or cardboard material and with two inner intermediate layers 103, 104 of an identical pre-ceramic paper and/or cardboard material, and the pre-ceramic paper layers and/or cardboard layers can be joined together into a composite especially by cementing. In the composite, the two inner intermediate layers 103, 104 form a spacer for the outer separating layers 102. A ceramic can be produced in the manner known from the prior art from the composite which can be obtained by joining of the separating layers 102 to the intermediate layers 103, 104 by thermal conversion of the paper structures and/or cardboard structures.

According to FIG. 14, the separating layers 102 and the intermediate layers 103, 104 are made flat or planar; this facilitates molded connection of the paper and/or cardboard structures to one another, especially by lamination, and ensures a high strength of the composite, and thus, of the formed ceramic body which can be obtained from the composite. It is possible for the composite, after joining of the paper and/or cardboard structures and before ceramicization, to be subjected to a forming method in order to obtain a certain shape of the ceramic which is reproduced in the composite structure.

As follows further from FIG. 14, the intermediate layers 103, 104 have a plurality of surface openings 111, 112 which are arranged regularly according to FIG. 10 and which can have the same size and shape. On the one hand, a low weight of the composite which can be obtained from the paper and/or cardboard structures and thus of the ceramic which can be obtained is achieved by the surface openings 111, 112. The surface openings 111 of a first inner intermediate layer 103, 104 and the surface openings 112 of a second lower intermediate layer 103, 104 are arranged turned by 90° relative to one another. The remaining surfaces of the intermediate layers 103, 104 are cemented to one another and to the outer separating layers 102 so that a high strength of the composite, and thus, of the ceramic which can be obtained from the composite is achieved. The number of inner intermediate layers 103, 104 can be chosen at will in order to achieve a certain distance between the outer separating layers 102, and thus, a certain thickness and stability of the composite 101.

As follows from FIGS. 15 to 22, the surface openings 111 in a first intermediate layer 103, 104 and the surface openings 112 in a connected second intermediate layer 103, 104 can be made complementary and can be arranged on top of one another in areas in a composite 101. The overlapping surface openings 111, 112 form interconnected cavities, voids and channels in the connected intermediate layers 103, 104 which are preserved when the composite 101 is ceramicized. Preferably here it is such that a flow through the ceramic structure which can be obtained in this way is possible in at least two directions of space Y₁, Y₂.

The surface openings 111 of a first intermediate layer 103, 104 according to FIG. 15 and FIG. 16 extend in the flow direction Y₁, while the surface openings 112 of a bordering second intermediate layer 103, 104 extend transversely thereto in the flow direction Y₂. The surface openings 111 are connected to one another via the surface openings 112 which run transversely thereto and vice versa. In this way, fluid channels are formed in the filter ceramic in both flow directions Y₁, Y₂.

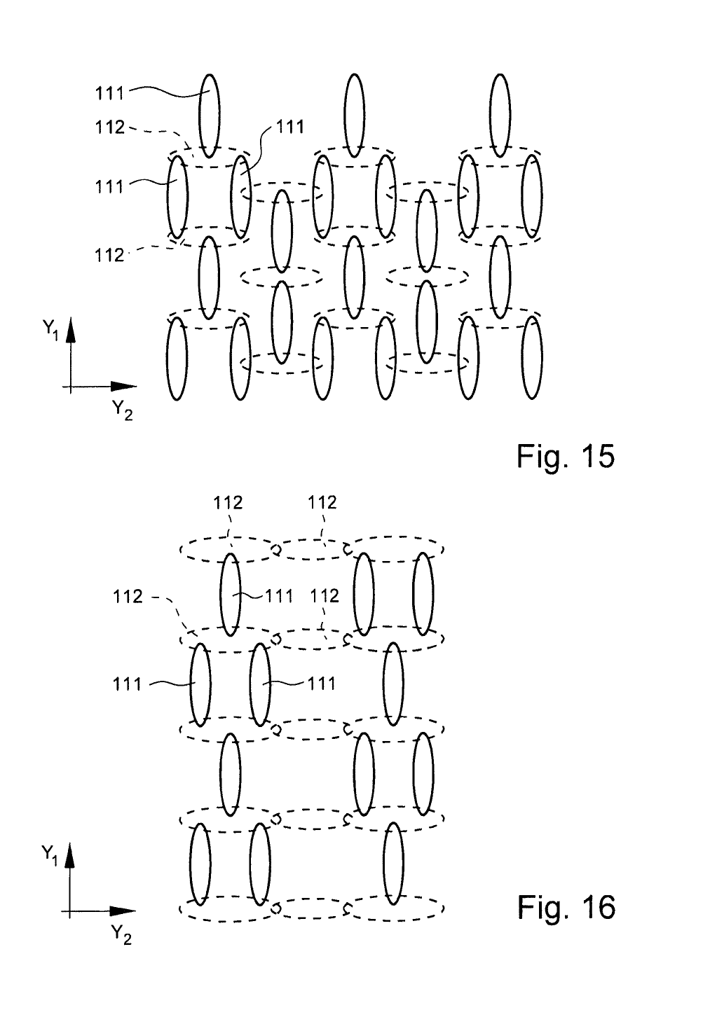

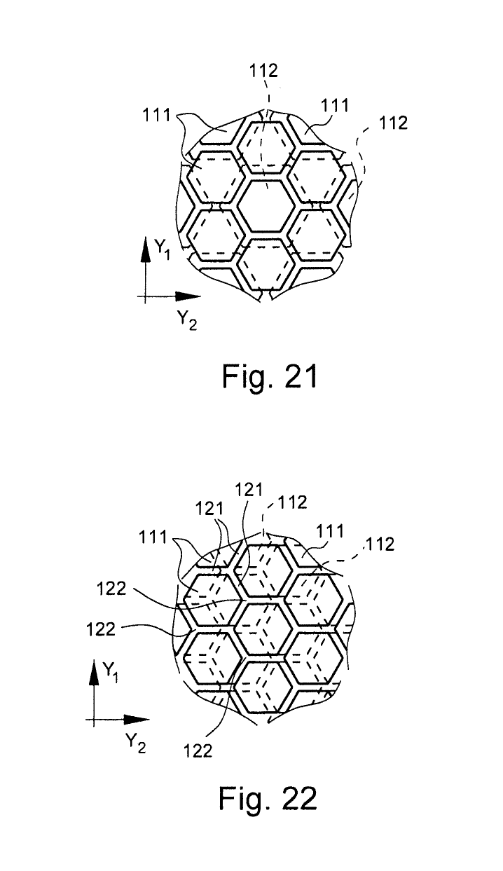

As follows further from FIGS. 15 to 22, the surface openings 111, 112 of an intermediate layer 103, 104 can be arranged regularly distributed. According to FIGS. 15, 16 and 19, the surface openings 111, 112 are made elongated and elliptical. According to FIG. 20, the surface openings 111, 112 are made as slots. According to FIG. 17, the recesses 111, 112 can also be circular. According to FIGS. 18 and 21, the recesses 111, 112, and 113 can also be rectangular, triangular or honeycombed.

The embodiment of FIG. 18 has triangular surface openings 111 of a first intermediate layer 103, 104 and rectangular surface openings 112 of a second intermediate layer 103, 104 which are arranged in alternation, and in the embodiments of FIGS. 21 and 22, hexagonal and honeycombed surface openings 111, 112 provide correspondingly larger cavities and openings in the connected intermediate layers 103, 104 as a result of the comparatively small total connecting area between the intermediate layers 103, 104 and separating layers 102.

Moreover, the surface openings of an intermediate layer 103, 104 are preferably identically contoured. In the embodiments which are shown in FIGS. 14 and 15, the surface openings 111, 112 are identically contoured. The same applies to the embodiments shown in FIGS. 20 and 22.

As follows from FIGS. 17, 18, 19 and 21, the surface openings 111, 112 of the two intermediate layers 103, 104 can also be contoured differently. In particular, they can have a different size. For example, in the embodiments shown in FIGS. 17 and 21, it is provided that the surface openings 111 of a first intermediate layer 103, 104 are of the same shape, but are smaller than the surface openings 112 of a bordering second intermediate layer 103, 104. Here, a plurality of surface openings 111 can be connected to a respective larger surface recess 112.

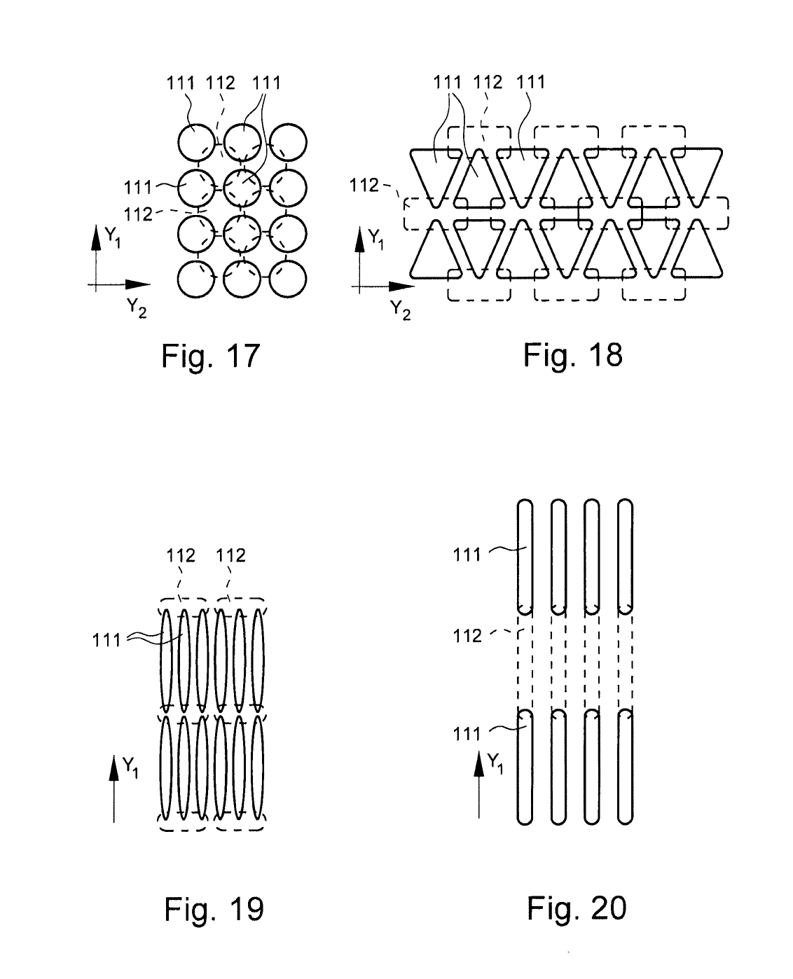

According to the embodiments which are shown in FIGS. 19 and 20, flow through the intermediate layer 110, 113 in the ceramic filter body 105 can also be possible only in one flow direction Y₁ by a certain alignment of the surface openings 111, 112. According to FIG. 19, this follows from the surface openings 111 which are arranged in the flow direction Y₁ and surface openings 112 which are located transversely thereto. The surface openings 112 each connect only part of the surface openings 111 which are located next to one another so that flow routing transversely to the flow direction Y₁ is possible only over a small region of the intermediate layers 103, 104 which are connected to one another. According to FIG. 20, all surface openings 111, 112 extend in the flow direction Y₁, fluid overflow from one surface recess 111 into an adjacent surface recess 111 transversely to the flow direction Y₁ not being possible.

FIG. 22 shows a preferred embodiment in which the surface openings 111, 112 of two intermediate layers 103, 104 have the same contour. The intermediate layers 103, 104 have a honeycombed or net-like structure with crosspieces 121 whose connecting sites 122 form corner points of the surface openings 111, 112. The interconnected layers 103, 104 can be arranged offset or turned relative to one another. Preferably, the layers 103, 104 are arranged offset with respect of one another or turned such that at least some connecting sites 122 of an upper first intermediate layer 103, 104 are located above the surface openings 112 or openings in an underlying second intermediate layer 103, 104. In this way, a very low flow resistance is ensured when flow takes place through the intermediate coating 110, 113.

1-20. (canceled)

21. A ceramic obtained from a composite comprising at least two cover coatings formed of outer pre-ceramic structures formed of at least one of pre-ceramic paper and pre-ceramic cardboard structures and an intermediate layer and spacer for the at least two cover coatings formed of at least one inner pre-ceramic structure formed of at least one of pre-ceramic paper and pre-ceramic cardboard structures,
wherein the at least one inner pre-ceramic structure is joined in a blanket manner in the composite on at least one of a top and bottom to at least one outer pre-ceramic structure and to at least one of another inner pre-ceramic structure and another outer pre-ceramic structure, and
wherein the inner pre-ceramic structure has a plurality of surface openings.

22. The ceramic as claimed in claim 21, wherein the composite has at least two inner pre-ceramic structures which are connected to one another in a blanket manner.

23. The ceramic as claimed in claim 22, wherein the surface openings of a first of the at least two inner pre-ceramic structures of the composite and the surface openings of a bordering second of the at least two inner pre-ceramic structures have a complementary shape so that, in the composite, the surface openings in the bordering inner pre-ceramic structures are located at least partially on top of one another in regions.

24. The ceramic as claimed in claim 23, wherein the surface openings are connected to one another in a manner forming interconnected flow routing channels in the ceramic.

25. The ceramic according to claim 21, wherein the inner pre-ceramic structure has a thickness between 0.1 mm to 2.0 mm, and corresponding to a thickness of the outer pre-ceramic structure.

26. The ceramic according to claim 21, wherein the surface openings are regularly distributed across the inner pre-ceramic structure and have any of circular, elliptical and polygonal shapes.

27. The ceramic according to claim 22, wherein the surface openings of a first the inner pre-ceramic structures of the composite have an identical contour as the surface openings of a second of the inner pre-ceramic structure of the composite.

28. The ceramic according to claim 22, wherein the surface openings of a first of the inner pre-ceramic structures of the composite are smaller than the surface openings of a bordering second one of the inner pre-ceramic structures, each surface openings of the first of the inner pre-ceramic structures being connected to at least one opening of the second of the inner pre-ceramic structures to route flow.

29. A lightweight component with a ceramic obtained from a composite, comprising at least two cover coatings formed of outer pre-ceramic structures formed of at least one of pre-ceramic paper and pre-ceramic cardboard structures and an intermediate layer and spacer for the at least two cover coatings formed of at least one inner pre-ceramic structure formed of at least one of pre-ceramic paper and pre-ceramic cardboard structures,
wherein the at least one inner pre-ceramic structure is joined in a blanket manner in the composite on at least one of a top and bottom to at least one outer pre-ceramic structure and to at least one of another inner pre-ceramic structure and another outer pre-ceramic structure, and
wherein the inner pre-ceramic structure has a plurality of surface openings.

30. A filter having a filter body formed of a ceramic formed from a composite comprising at least two cover coatings formed of outer pre-ceramic structures formed of at least one of pre-ceramic paper and pre-ceramic cardboard structures and an intermediate layer and spacer for the at least two cover coatings formed of at least one inner pre-ceramic structure formed of at least one of pre-ceramic paper and pre-ceramic cardboard structures,
wherein the at least one inner pre-ceramic structure is joined in a blanket manner in the composite on at least one of a top and bottom to at least one outer pre-ceramic structure and to at least one of another inner pre-ceramic structure and another outer pre-ceramic structure, and
wherein the inner pre-ceramic structure has a plurality of surface openings.

31. A filter, comprising at least one ceramic filter body as a filter element, the ceramic filter body being formed of a ceramicized multilayer composite of flat pre-ceramic layers that have been ceramicized, wherein the composite has at least one separating layer arrangement with at least one separating layer of a pre-ceramic material and at least one intermediate layer which is connected to the separating layer and which is composed of a pre-ceramic material as a spacer for the separating layer, the separating layer forming a separating coating and the at least one intermediate layer forming an intermediate coating and through-flow zone for flow in the ceramic filter body, the separating layer having closed flat sides and the intermediate layer having a plurality of surface openings and being connected in a blanket manner on a top or bottom side to the separating layer.

32. The filter as claimed in claim 31, wherein the composite has a plurality of separating layer arrangements which lie next to one another, each separating layer arrangement having at least two separating layers and at least one intermediate layer between the separating layers, and wherein adjacent separating layer arrangements are connected via at least one other intermediate layer which is located between the separating layer arrangements as a spacer for the separating layer arrangements.

33. The filter as claimed in claim 32, wherein adjacent intermediate layers of the ceramic filter body are separated from one another by a separating layer.

34. The filter according to claim 32, wherein, between at least two separating layers of the composite, there are at least two intermediate layers which are connected to one another, the interconnected intermediate layers having surface openings which overlap in regions and which form at least one flow channel between the separating layers.

35. The filter according to claim 31, wherein the ceramic filter body has a collecting channel which extends in a axial direction of the filter body, and wherein the separating layers and intermediate layers are arranged helically around a periphery of the collecting channel.

36. The filter as claimed in claim 35, wherein the collecting channel is connected to at least one intermediate coating to route the flow.

37. The filter according to claim 35, wherein the composite has a tubular body of a pre-ceramic material, the separating layers and the intermediate layers being arranged distributed over a periphery of the tubular body and being attached to the tubular body.

38. The filter according to claim 35, wherein the composite has a tubular green body, the separating layers and the intermediate layers being arranged distributed over a periphery of the green body and being attached to the green body.

39. The filter according to claim 35, wherein the separating layers and the intermediate layers in the composite are arranged wound helically around the cavity.
